(19) United States
(12) Patent Application Publication
(10) Pub. No.: US 2014/0339151 A1
(43) Pub. Date: Nov. 20, 2014

(54) DISPOSABLE FILTERING CARTRIDGE, FOR THE INFUSION OF AROMATIC HERBS, COFFEE, TEA AND OTHERS

(71) Applicant: Gonzalo Felipe Llach Villalobos, Las Condes (CL)

(72) Inventor: Gonzalo Felipe Llach Villalobos, Las Condes (CL)

(21) Appl. No.: 14/006,705

(22) PCT Filed: Apr. 20, 2012
(86) PCT No.: PCT/CL2012/000018

§ 371 Date: Aug. 8, 2014

(30) Foreign Application Priority Data
May 12, 2011 (CL) 1074-2011

(51) Int. Cl. A47J 31/06

(52) U.S. Cl. CPC A47J 31/0636
USPC 210/470

(57) ABSTRACT

A disposable cartridge, to be used as a filter, specifically for the infusion of soluble elements, aromatic herbs such as tea, coffee, chamomile, equipped with fastening means, is made up of a laminar template, divided into three sections of straight edges, one central section, which makes up the container and two similar side sections arranged obliquely, which, when overlapped constitute a rear straight wall, the side sections arranged obliquely are equipped with an extension or section, that make up a handle when overlapping, both equipped with a tab, a smaller one for fastening and a larger tab, both are the means used to fasten to an annular ring of a cup or similar.

### BACKGROUND OF THE INVENTION

This invention refers to a disposable cartridge to be used as a filter, specifically for the infusion of soluble elements, aromatic herbs such as tea, coffee, chamomile, etc., made up of a laminar template divided into three sections, which make up this cartridge, which includes holes and a type of handle to fasten it inside a cup or any other desired element, which allows to avoid the use of other elements to hold it and due to the material used, allows to dispose of it once it has been used.

With response to the state of the art, for cartridges or cones, specifically used to infuse soluble elements, we can cite U.S. Pat. No. 4,220,541, which refers to a disposable filter to prepare coffee, tea or similar products, intended for the use and to be used without a support, which consists of a carton in the shape of an annular disc formed with a quadrant to be removed flat and shaped as a funnel, and a circular filter paper which is placed concentrically inside the container through which water can be poured through the central area of the filter, where a triangular-shaped space is formed on the outside of the peripheral of the carton, an apex of the cavity is radially directed towards the exterior, with which it elevated in the position of the container of the peripheral area of the cardboard cup, it can be folded along a peripheral line through the spaces so that the neck is formed around the container.

Another invention is ES 2,195,481, which refers to a filter for filtered beverages, specifically for a filter for coffee and a procedure for the manufacturing of this type of filter, where a fibrous material is used with pores that have a minimum pore opening (d) of approximately 0.1 mm measured with a fiber density that makes up approximately 50% of the original fiber density of the material, the average pore opening (d) is preferably located in a range of approximately 0.1 mm until approximately 0.7 mm, and even more preferably in a range of approximately 0.1 mm until approximately 0.4 mm., the material is preferably paper, the pores are preferably made with needle perforation or water jet of fibrous material, this way a edge of pores is formed that is not clear-cut.

With regard to the deficiencies and disadvantages that currently exist, with cartridges, used to prepare and filter aromatic herbs, a cartridge has been created to be practical, made to be securely fastened and stable, as well as properly containing the aromatic herbs on the inside of the cartridge and extracting the soluble parts efficiently, which is not found in current cartridges, since in order to be stable they are made to cover the entire annular diameter of the cup or glass.

### DESCRIPTION OF DRAWINGS

For the most clear understanding of the makeup of the cartridge and means to be used as a filter, specifically to extract the infusion of soluble elements such as aromatic herbs, it is described according to the drawings that form an integral part of this presentation, without limiting it from obvious modifications that may arise, whereby:

FIG. 1 shows a plan view of the laminar template to form the cartridge.

FIG. 2 shows a side view of the cartridge for the infusion of aromatic herbs.

FIG. 3 shows a front view of the cartridge, for the extraction of the infusion of aromatic herbs.

FIG. 4 shows a rear view of the cartridge, for the infusion of aromatic herbs.

FIG. 5 shows a top view of the assembly sequence and top area of the cartridge of the invention.

FIG. 6 shows a view of the assembly sequence of the cartridge, viewed from the front.

FIG. 7 shows a rear view of the cartridge in an assembly sequence.

FIG. 8 shows an isometric view of the cartridge of the invention.

FIG. 9 shows a top view of a drinking cup and the cartridge viewed from the front and installed on the inside of this cup.

FIG. 10 shows a top view of the cartridge of the invention, installed on the inside of a drinking cup.

### DESCRIPTION OF THE INVENTION

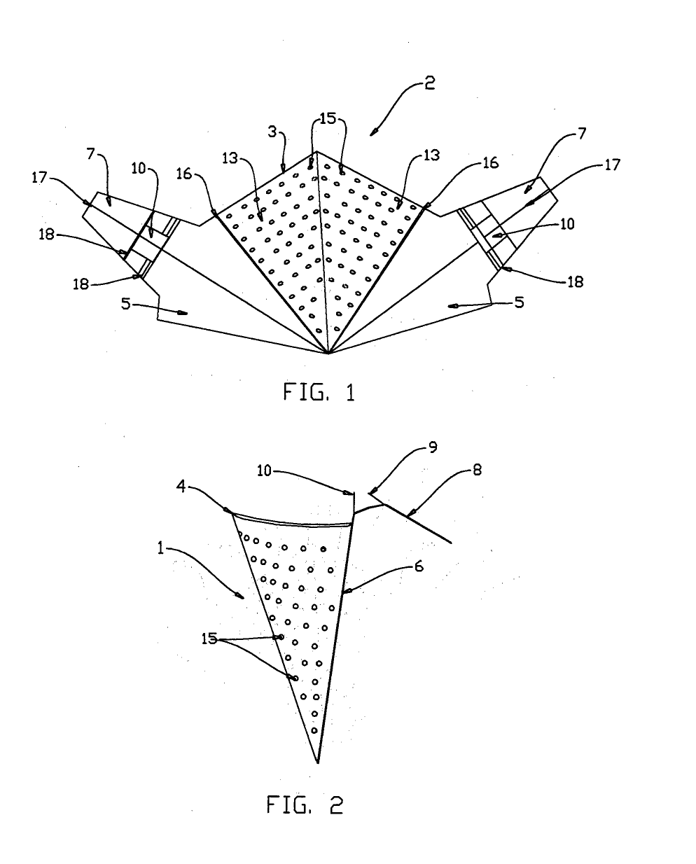

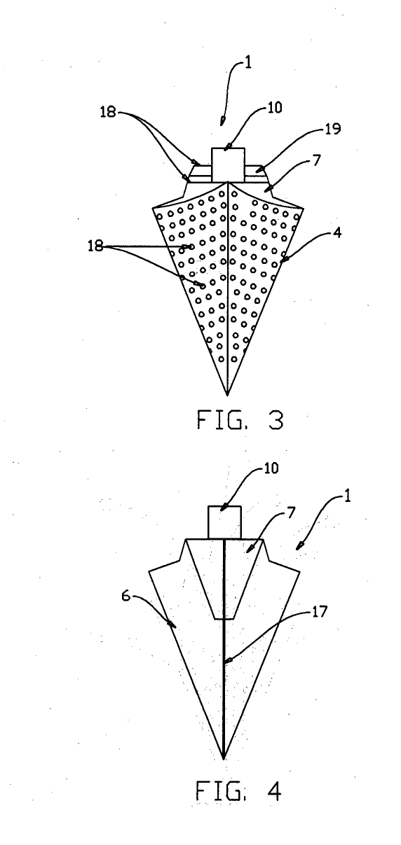

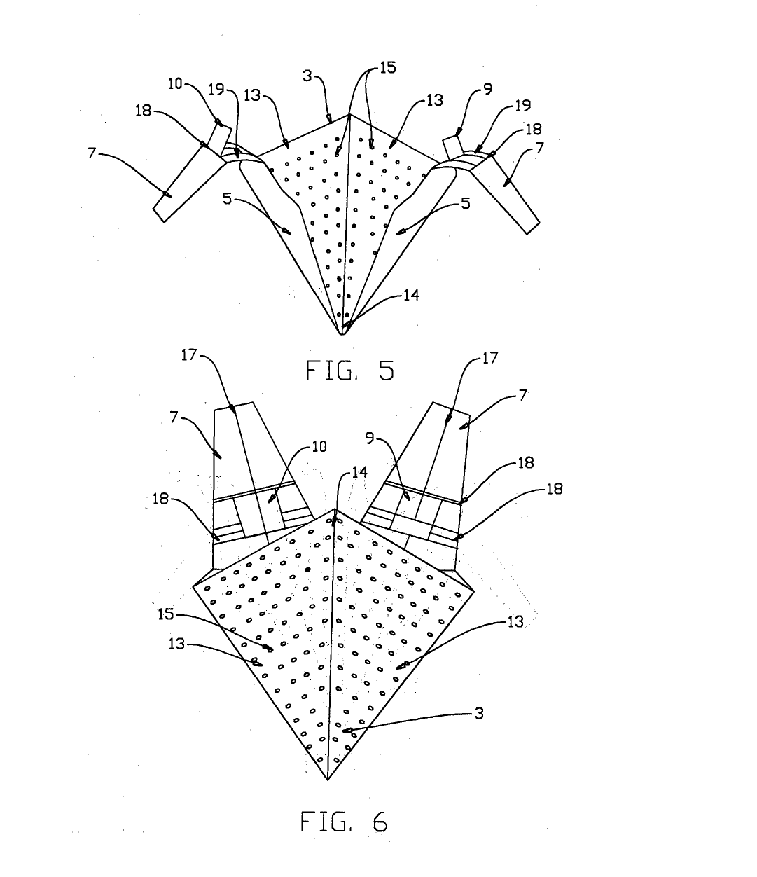

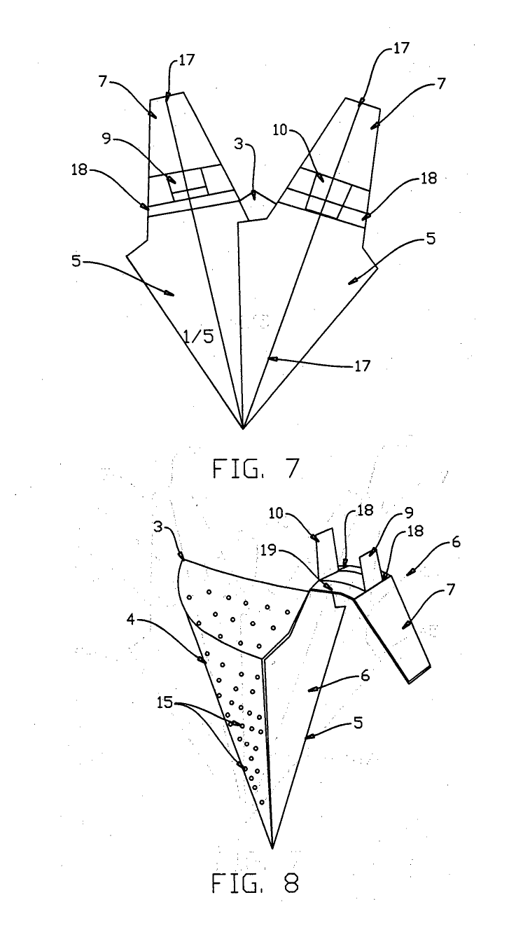

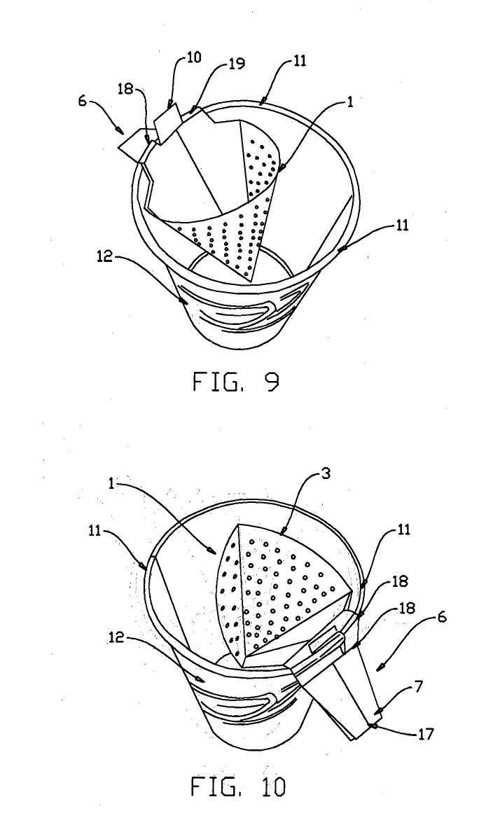

According to FIGS. 1 to 6, the cartridge for the infusion of aromatic herbs (1), is formed with a laminar template (2), divided into three straight edge sections, a central section (3), which makes up the container (4) and two similar lateral sections arranged obliquely (5), which when overlapping make up a straight rear wall (6). Such lateral sections arranged obliquely (5), are equipped with an extension or section (7), which when overlapping create a handle (8), both having a tab, one that is smaller (9) for fastening and a larger tab (10), both are to attach to the annular right (11) of a cup (12) or similar.

The central section (3) has two triangular sections (13), divided with a central demarcation (14); also, this central section (3), includes equidistant holes (15), for the outgoing of the essence o substance of the aromatic herbs towards the inside of the cup (12), likewise, through the lateral corners of such central section (3) of the cartridge (1), they join with the similar lateral oblique sections (5) with the folds (16) of the mentioned cartridge template (1), which have a triangular section configuration, with a central linear demarcation (17) as a guide and followed by the lower area with the extension or inverted truncated triangular section configuration section (7) equipped with crossfolds (18); in addition, both truncated triangular sections (7), have a small tab (9) and large tab (10), these are created from the body of these truncated triangular sections (7), with the small tab (9), being folded and hooked onto the ring or annular edge (11) of the cup (12), and the other large tab (10) is placed perpendicular to this annular edge (11), so that the cartridge is fastened inside the cup (12).

To assemble the cartridge (1), first the pleats (16) must be folded upward, with the oblique triangular lateral sections (5), which are divided with the central section (3) of the cartridge (1), along with the truncated triangular extensions (7), until the triangular sections (5) and truncated triangular sections—(7), are completely overlapping; once overlapping, they must be folded downward below the folding pleats (18) with the truncated triangular extensions (7), so as to form an upper flat sector (19) leaving the upper area of the extension truncated (7), parallel to the wall of the cup (12) or the wall (6) of the triangular lateral sections (5); following the above, the tabs must be folded; the smaller tab (9) is folded over the annular ring (11) of the cup (12), and the larger tab (10), must be folded upward so that it is perpendicular to the cartridge (1), this way the cartridge (1) remains inside and attached to one side of the cup (12).

1. A disposable cartridge, to be used as a filter, specifically for the infusion of soluble elements, aromatic herbs such as tea, coffee, chamomile, with a configuration that allows it to be securely fastened and stable without using the entire annular diameter of a cup or glass, CHARACTERIZED because it is made up of a laminar template (2), divided into three straight-edge sections, one central section (3), which makes up the container (4) and two similar side sections arranged obliquely (5), which when overlapped make up a rear straight wall (6); these side sections are arranged obliquely (5) and are equipped with an extension or section (7), which create a handle when overlapping (8), both including a tab, a smaller (9) for fastening and a larger tab (10), both are the means of fastening to the annular ring (11) of a cup (12) or similar:

2. A disposable cartridge, according to claim 1, CHARACTERIZED because the central section (3) shows two triangular sections (13), divided with a central demarcation (14); also, such central section (3), has equidistant holes (15), for the outgoing of the essence or substance of the aromatic herbs towards the inside of the cup (12), likewise, through the lateral corners of such central section (3) of the cartridge (1), they join with the lateral oblique sections (5) with the folds (16) of the mentioned cartridge template (1).

3. A disposable cartridge, according to claim 1 , CHARACTERIZED because the oblique sections (5) show a triangular section configuration, with a central linear demarcation (17) as a guide and followed by an extension or an inverted truncated triangular section (7), equipped with crossfolds (18); also, both truncated triangular sections (7), have a small tab (9) and large tab (10), they are a product of the body of such truncated triangular sections (7), with the small tab (9), to be folded and hooked with to the ring or annular edge (11) of the cup (12), and the other larger tab (10), is placed perpendicularly to this annular edge (11), so that the cartridge remains held inside such cup (12).
